(19) United States
(12) Patent Application Publication
(10) Pub. No.: US 2025/0126241 A1
(43) Pub. Date: Apr. 17, 2025

(54) INHERITING LOCAL ILLUMINATION COMPENSATION PARAMETERS IN MERGE MODE IN VIDEO CODING

(71) Applicant: QUALCOMM Incorporated, San Diego, CA (US)

(72) Inventors: Han Huang, San Diego, CA (US); Vadim Seregin, San Diego, CA (US); Marta Karczewicz, San Diego, CA (US)

(21) Appl. No.: 18/884,960

(22) Filed: Sep. 13, 2024

Related U.S. Application Data
(60) Provisional application No. 63/590,339, filed on Oct. 13, 2023.

(51) Int. Cl. H04N 19/105; H04N 19/124; H04N 19/132; H04N 19/139; H04N 19/159; H04N 19/176; H04N 19/463; H04N 19/52

(52) U.S. Cl. CPC H04N 19/105; H04N 19/124; H04N 19/132; H04N 19/139; H04N 19/159; H04N 19/176; H04N 19/463; H04N 19/52

(57) ABSTRACT

A video coder configured to receive a block of video data to be coded using merge mode and local illumination compensation (LIC), and determine a merge candidate for the block of video data. If the merge candidate is a non-adjacent candidate or a history-based motion vector predictor candidate, the video coder is configured to inherit LIC parameters associated with the merge candidate. If the merge candidate is an adjacent candidate, the video coder is configured to derive LIC parameters for the block of video data using a neighboring template of reconstructed samples and a reference template in a reference frame.

This application claims the benefit of U.S. Provisional Application No. 63/590,339, filed Oct. 13, 2023, the entire contents of which are hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (Por B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inter prediction in video codecs. More specifically, this disclosure describes techniques related to the interaction between local illumination compensation (LIC) and merge mode. LIC is an inter prediction technique that models local illumination variation between a current block and its prediction block as a function of a current block template and a reference block template.

In one example of the disclosure, a video coder may be configured to determine LIC parameters for a current block of video data based on a type of merge candidate used for coding the current block of video data with merge mode. If the merge candidate is a non-adjacent candidate or a history-based motion vector predictor, the video coder may be configured to inherit LIC parameters from the merge candidate. That is, rather than deriving new LIC parameters, the video coder may reuse already determined LIC parameters associated with the merge candidate. If the merge candidate is an adjacent merge candidate, the video coder may derive new LIC parameters for the current block using a neighboring template of reconstructed samples and a reference template in a reference frame.

The use of a non-adjacent merge candidate or history-based motion vector predictor may be suggestive that adjacent blocks (e.g., adjacent merge candidates) are significantly different than the current block, at least in terms of having correlated motion information. As such, deriving new LIC parameters using adjacent samples in this situation may lead to less optimal LIC parameters. Accordingly, inheriting LIC parameters associated with the non-adjacent merge candidate or history-based motion vector predictor may lead to better coding efficiency and/or reduced distortion.

In one example, this disclosure describes a method of coding video data, the method comprising receiving a first block of video data to be coded using merge mode and LIC, determining a first merge candidate for the first block of video data, inheriting first LIC parameters associated with the first merge candidate based on the first merge candidate being a non-adjacent candidate or a history-based motion vector predictor candidate, and coding the first block of video data using the first merge candidate and the first LIC parameters.

In another example, this disclosure describes an apparatus configured to code video data, the apparatus comprising a memory, and processing circuitry in communication with the memory, the processing circuitry configured to receive a first block of video data to be coded using merge mode and LIC, determine a first merge candidate for the first block of video data, inherit first LIC parameters associated with the first merge candidate based on the first merge candidate being a non-adjacent candidate or a history-based motion vector predictor candidate, and code the first block of video data using the first merge candidate and the first LIC parameters.

In another example, this disclosure describes a non-transitory computer-readable storage medium storing instructions that, when executed, cause one or more processors of a device configured to code video data to receive a first block of video data to be coded using merge mode and LIC, determine a first merge candidate for the first block of video data, inherit first LIC parameters associated with the first merge candidate based on the first merge candidate being a non-adjacent candidate or a history-based motion vector predictor candidate, and code the first block of video data using the first merge candidate and the first LIC parameters.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating example positions of spatial merge candidates.

FIG. 3 is a conceptual diagram illustrating example candidate pairs considered for redundancy check of spatial merge candidates.

FIG. 4 is a conceptual diagram illustrating an example of motion vector scaling for temporal merge candidates.

FIG. 5 is a conceptual diagram illustrating example candidate positions for temporal merge candidate C₀ and C₁.

FIG. 6 is a conceptual diagram illustrating example spatial neighboring blocks used to derive spatial merge candidates.

FIG. 7 is a conceptual diagram illustrating an example of a merge mode with motion vector difference (MMVD) search point.

FIG. 8 is a conceptual diagram illustrating an example of bilateral matching.

FIG. 9 is a conceptual diagram illustrating an example of templating matching on search area around an initial motion vector.

FIG. 10 is a conceptual diagram illustrating an example of subblock template generation for subblock based temporal motion vector prediction.

FIG. 11 is a conceptual diagram illustrating an example of an extended coding unit region used in bi-directional optical flow.

FIG. 12 is a block diagram illustrating an example video encoder that may perform the techniques of this disclosure.

FIG. 13 is a block diagram illustrating an example video decoder that may perform the techniques of this disclosure.

FIG. 14 is a flowchart illustrating an example method for encoding a current block in accordance with the techniques of this disclosure.

FIG. 15 is a flowchart illustrating an example method for decoding a current block in accordance with the techniques of this disclosure.

FIG. 16 is a flowchart illustrating another example method for encoding a current block in accordance with the techniques of this disclosure.

### DETAILED DESCRIPTION

In general, this disclosure describes techniques for inter prediction in video codecs. More specifically, this disclosure describes techniques related to the interaction between local illumination compensation (LIC) and merge mode. LIC is an inter prediction technique that models local illumination variation between a current block and its prediction block as a function of a current block template and a reference block template.

In one example of the disclosure, a video coder may be configured to determine LIC parameters for a current block of video data based on a type of merge candidate used for coding the current block of video data with merge mode. If the merge candidate is a non-adjacent candidate or a history-based motion vector predictor, the video coder may be configured to inherit LIC parameters from the merge candidate. That is, rather than deriving new LIC parameters, the video coder may reuse already determined LIC parameters associated with the merge candidate. If the merge candidate is an adjacent merge candidate, the video coder may derive new LIC parameters for the current block using a neighboring template of reconstructed samples and a reference template in a reference frame.

The use of a non-adjacent merge candidate or history-based motion vector predictor may be suggestive that adjacent blocks (e.g., adjacent merge candidates) are significantly different than the current block, at least in terms of having correlated motion information. As such, deriving new LIC parameters using adjacent samples in this situation may lead to less optimal LIC parameters. Accordingly, inheriting LIC parameters associated with the non-adjacent merge candidate or history-based motion vector predictor may lead to better coding efficiency and/or reduced distortion.

A video encoder and/or video decoder may be configured to receive a first block of video data to be coded using merge mode and LIC, determine a first merge candidate for the first block of video data, inherit first LIC parameters associated with the first merge candidate based on the first merge candidate being a non-adjacent candidate or a history-based motion vector predictor candidate, and code (e.g., encode or decode) the first block of video data using the first merge candidate and the first LIC parameters.

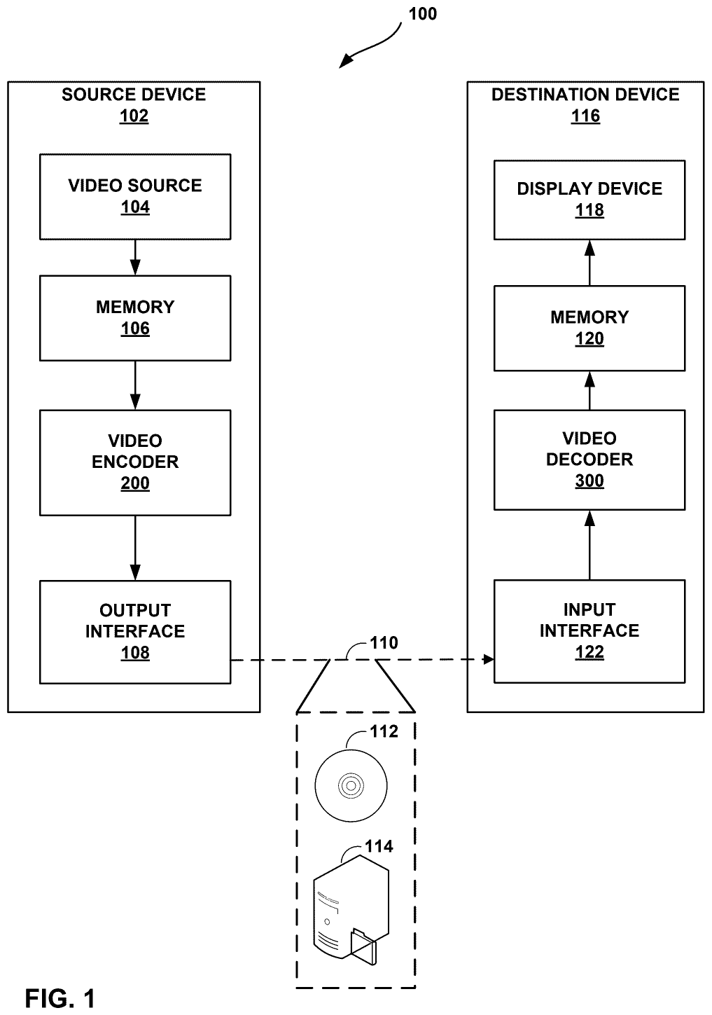

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for inter prediction and local illumination compensation. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for inter prediction and local illumination compensation. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use inter prediction and local illumination compensation.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, as will be explained in more detail below, video encoder 200 and video decoder 300 of FIG. 1 may be configured to perform one or more techniques of this disclosure for coding video data using local illumination compensation (LIC) and/or merge mode. For example, video encoder 200 and video decoder 300 may be configured to determine LIC parameters for a current block of video data based on a type of merge candidate used for coding the current block of video data with merge mode. If the merge candidate is a non-adjacent candidate or a history-based motion vector predictor, video encoder 200 and video decoder 300 may be configured to inherit LIC parameters from the merge candidate. That is, rather than deriving new LIC parameters, video encoder 200 and video decoder 300 may reuse already determined LIC parameters associated with the merge candidate. If the merge candidate is an adjacent merge candidate, video encoder 200 and video decoder 300 may derive new LIC parameters for the current block using a neighboring template of reconstructed samples and a reference template in a reference frame.

### Local Illumination Compensation (LIC)

LIC is an inter prediction technique that models local illumination variation between a current block and its prediction block as a function of a current block template and a reference block template. The parameters of the function (e.g., the LIC parameters) can be denoted by a scale α and an offset β, which forms a linear equation, that is, α*p[x]+β. The function compensates illumination changes, where p[x] is a reference sample pointed to by a motion vector (MV) at a location x on reference picture. Since α and β can be derived based on a current block template and a reference block template, no signaling overhead is required for the LIC parameters, except that an LIC flag is signaled for advanced motion vector prediction (AMVP) mode to indicate the use of LIC.

One example of local illumination compensation proposed in V. Seregin, W.-J. Chien, T. Hsieh, N. Hu, M. Karczewicz, C.-M. Tsai, C.-C. Chen, C.-W. Hsu, Y.-W. Huang, S.-M. Lei, H. Chen, X. Ma, H. Yang, “CE4-3.1a and CE4-3.1b: Unidirectional local illumination compensation with affine prediction”, JVET-O0066, June 2019 (hereinafter, “JVET-O0066”) is used for uni-prediction inter CUs with the following modifications:
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

In X. Xiu, N. Yan, C. Ma, H.-J. Jhu, C.-W. Kuo, W. Chen, X. Wang, “EE2-Test2.7: Improvements on local illumination compensation”, JVET-AD0213, April 2023 (hereinafter “JVET-AD0213”), LIC mode is extended to bi-predictive CUs and is adopted into the enhanced compression model (ECM), where two different linear models are applied to the two prediction blocks which are then combined to generate the bi-prediction samples of the current CU, e.g.,

$${P}^{′} [ x , y ] = ( 1 - ω ) \cdot {p}_{0}^{′} [ x , y ] + ω \cdot {p}_{1}^{′} [ x , y ]$$

$$and$$

$${p}_{0}^{′} [ x , y ] = {α}_{0} \cdot {P}_{0} [ x , y ] + {β}_{0}$$

$${p}_{1}^{′} [ x , y ] = {α}_{1} \cdot {P}_{1} [ x , y ] + {β}_{1} ,$$

where α₀ and β₀, and α₁ and β₁ indicate the scales and the offsets in reference picture list L0 and reference picture list L1, respectively; w indicates the weight (as indicated by the CU-level BCW (bi-prediction with CU level weight) index) for the weighted combination of L0 and L1 predictions.

The method first derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signalled for AMVP bi-predicted CUs for the indication of the LIC mode while the flag is inherited for merge related inter CUs. Additionally, the LIC is disabled for decoder side motion vector refinement (DMVR) and bi-directional optical flow (BDOF).

### Regular Merge Mode

### Spatial Merge Candidates Derivation

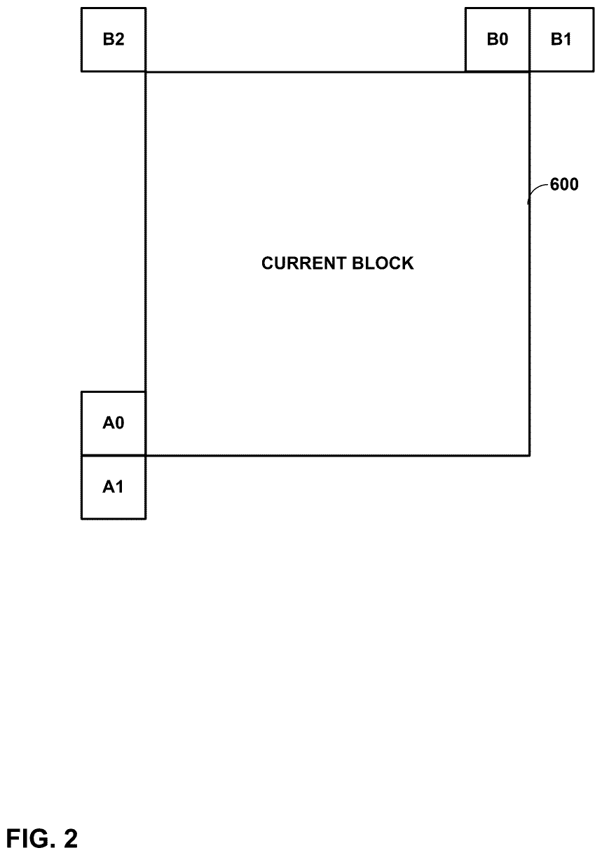

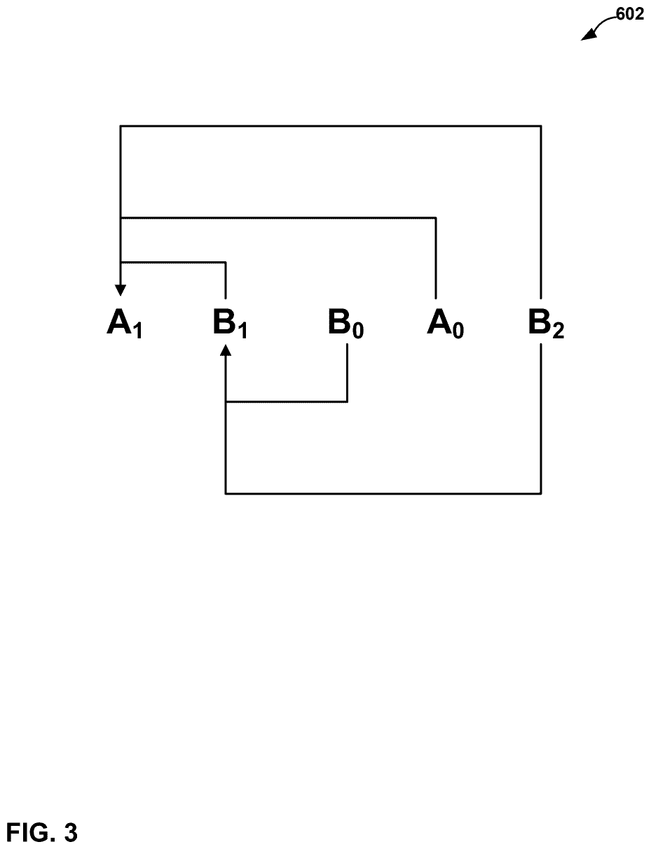

The derivation of spatial merge candidates in VVC is the same to that in HEVC. A maximum of four merge candidates are selected among candidates located in the positions relative to current block 600 depicted in FIG. 2. FIG. 2 is a conceptual diagram illustrating example positions of spatial merge candidates. The order of derivation is A₀, B₀, B₁, A₁ and B₂. Position B₂ is considered only when any CU of position A₀, B₀, B₁, A₁ is not available (e.g. because it belongs to another slice or tile) or is intra coded. After the candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 3 is a conceptual diagram illustrating example candidate pairs considered for redundancy check of spatial merge candidates. As shown in FIG. 3, only the pairs 601 linked with an arrow are considered and a candidate is only added to the list if the corresponding candidate used for redundancy check has not the same motion information.

### Temporal Candidates Derivation

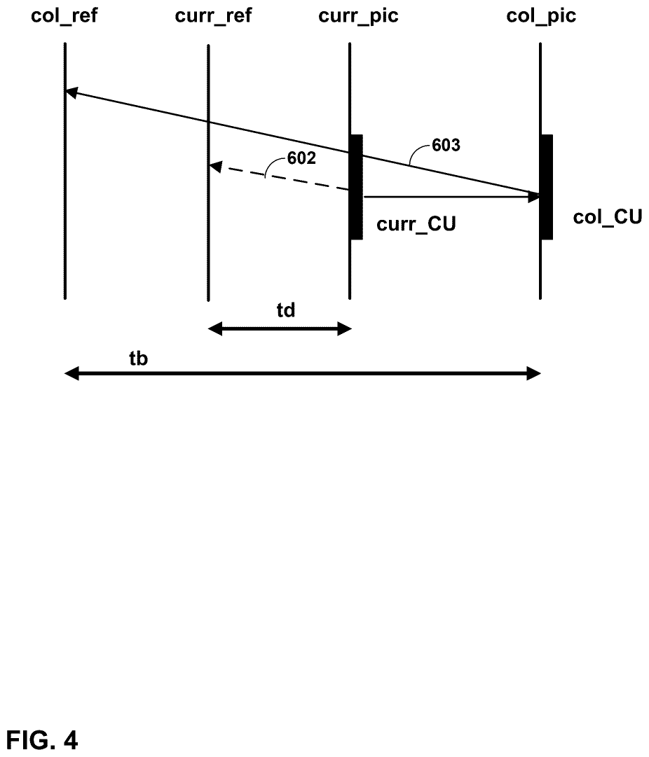

FIG. 4 is a conceptual diagram illustrating an example of motion vector scaling for temporal merge candidates. In one example, only one temporal merge candidate is added to the merge list. In the derivation of this temporal merge candidate, a scaled motion vector is derived based on a co-located CU (col_CU) belonging to the collocated reference picture (col_pic). The reference picture list to be used for derivation of the co-located CU is explicitly signaled in the slice header. The scaled motion vector 602 for temporal merge candidate is obtained as illustrated by the dotted line in FIG. 4, which is scaled from the motion vector 603 of the co-located CU using the picture order count (POC) distances, tb and td, where tb is defined to be the POC difference between the reference picture (curr_ref) of the current picture and the current picture (cur_pic) and td is defined to be the POC difference between the reference picture (col_ref) of the co-located picture and the co-located picture (col_pic). The reference picture index of temporal merge candidate is set equal to zero.

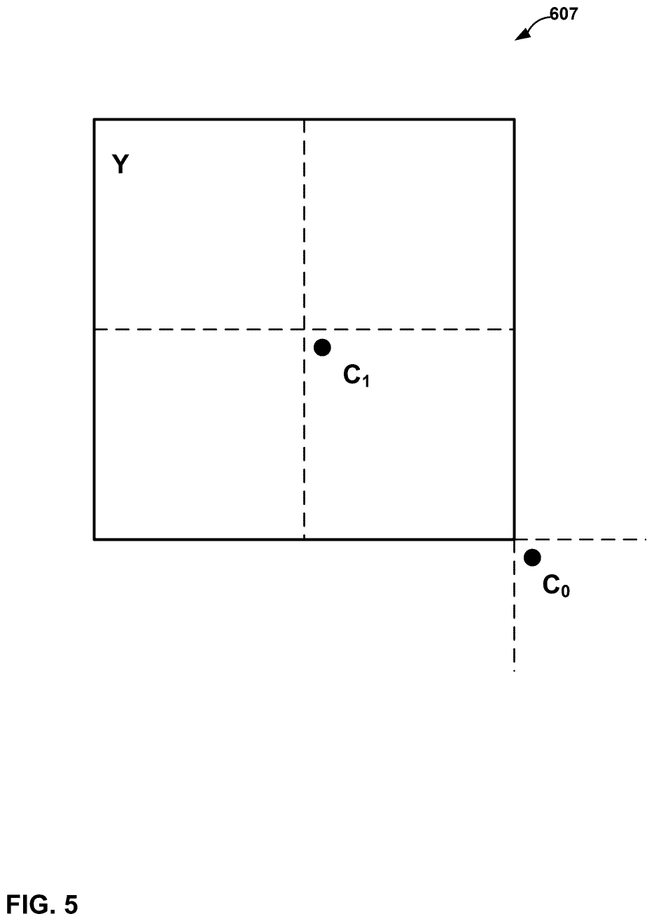

The position for the temporal candidate is selected between candidates C₀ and C₁ relative to block 607, as depicted in FIG. 5. FIG. 5 is a conceptual diagram illustrating example candidate positions for temporal merge candidate C₀ and C₁. If the CU at position C₀ is not available, is intra coded, or is outside of the current row of CTUs, position C₁ is used. Otherwise, position C₀ is used in the derivation of the temporal merge candidate.

### History-Based Merge Candidates Derivation

In some examples, the motion information of a previously coded block may be stored in a table (e.g., an HMVP table) and used as a motion vector predictor (MVP) for the current CU. The table with multiple entries is maintained during the encoding/decoding process. When inserting a new motion candidate to the table, a constrained first-in-first-out (FIFO) rule may be utilized, wherein a redundancy check is first applied to determine whether there is an identical candidate in the table. If found, the identical candidate is removed from the table and all the other candidates afterwards are moved forward.

In one example, HMVP candidates are added to a merge list after the spatial and temporal merge candidates, wherein the latest several HMVP candidates in the table are checked in order and inserted to the candidate list after the TMVP candidate. Some redundancy checks are applied on the HMVP candidates before insertion into the merge list.

### Pair-Wise Average Merge Candidates Derivation

In some examples, pairwise average candidates may be generated by averaging predefined pairs of candidates in the existing merge candidate list. The averaged motion vectors are calculated separately for each reference list. If both motion vectors are available in one list, these two motion vectors are averaged even when they point to different reference pictures. If only one motion vector is available, it may be used directly. If no motion vector is available, the list is marked as invalid.

When the merge list is not full after pair-wise average merge candidates are added, zero MVPs are inserted at the end of the list until the maximum merge candidate number is reached.

### Non-Adjacent Spatial Candidates

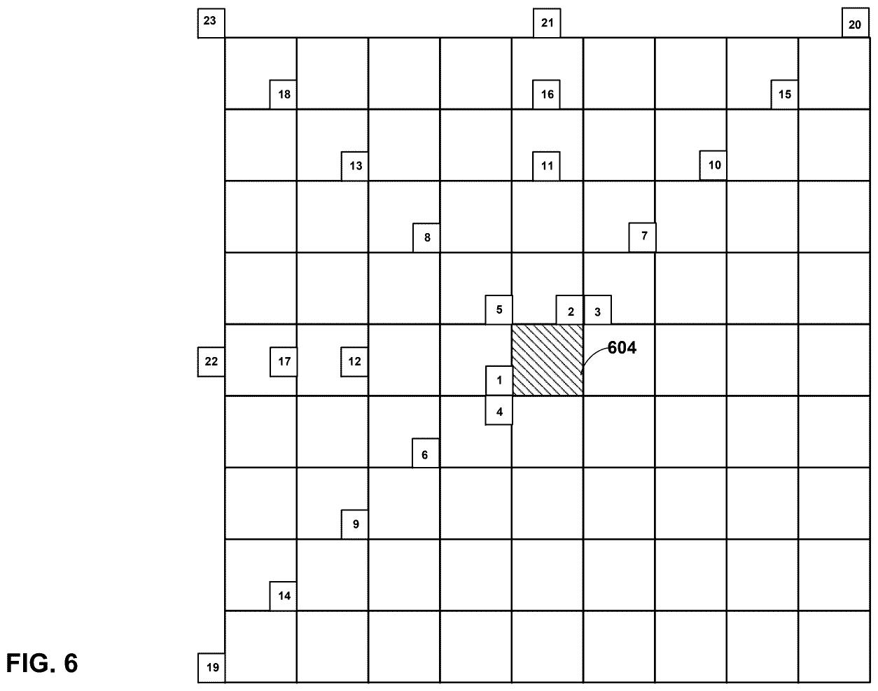

In ECM, a new type of regular merge candidate, called a non-adjacent spatial merge candidates, is introduced. The non-adjacent spatial merge candidates, as in JVET-L0399, are inserted after the temporal motion vector prediction (TMVP) in the regular merge candidate list. The pattern of spatial merge candidates around current block 604 is shown in FIG. 6. FIG. 6 is a conceptual diagram illustrating example spatial neighboring blocks used to derive spatial merge candidates. The distances between non-adjacent spatial candidates (e.g., candidates 6-23) and current coding block 604 are based on the width and height of current coding block. A line buffer restriction is not applied.

Merge Mode with Motion Vector Difference (MMVD)

In addition to merge mode, where the implicitly derived motion information is directly used for prediction samples generation of the current CU, the merge mode with motion vector differences (MMVD) has been introduced in VVC. In MMVD, after a merge candidate is selected, the merge candidate is further refined by the signaled MVD information. The further information includes a merge candidate flag, an index to specify motion magnitude, and an index for indication of motion direction. In MMVD mode, one of the first two candidates in the merge list is selected to be used as the MV basis. The merge candidate flag is signaled to specify which merge candidate is used.

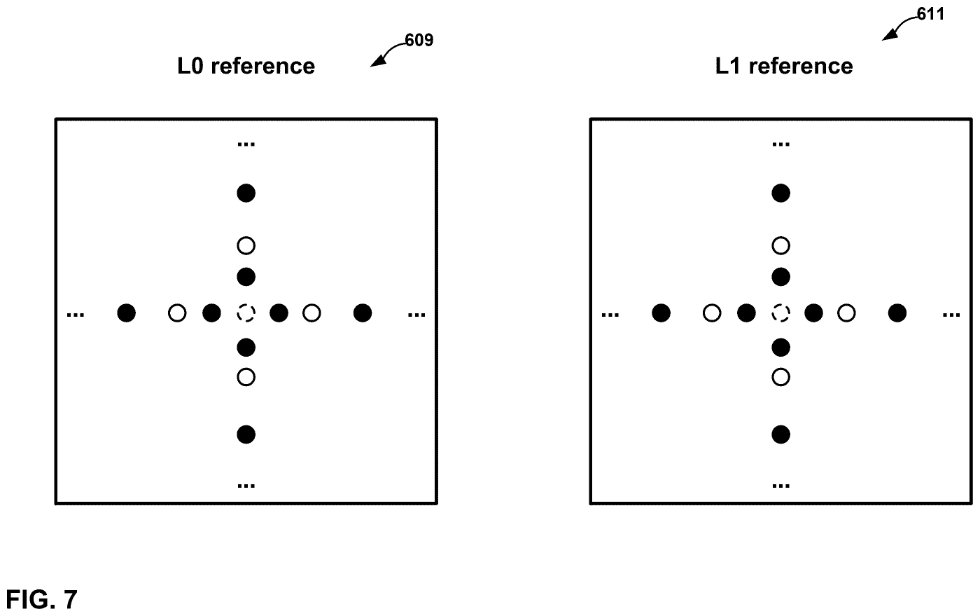

A distance index specifies motion magnitude information and indicates the predefined offset from the starting point. FIG. 7 is a conceptual diagram illustrating an example of a merge mode with MMVD search point. As shown in FIG. 7, an offset is added to either horizontal component or vertical component of a starting MV in either reference list L0 609 or reference list L1 611. The relation of distance index and predefined offset is specified in Table 1-1 below.

TABLE 1-1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

A direction index represents the direction of the MVD relative to the starting point. The direction index can represent the four directions, as shown in Table 1-2 below. The meaning of the MVD sign could vary according to the information of the starting MVs. When the starting MV is a uni-prediction MV or bi-prediction MVs with both lists pointing to the same side of the current picture (e.g., the POCs of two references are both larger than the POC of the current picture, or are both smaller than the POC of the current picture), the sign in Table 1-2 specifies the sign of MV offset added to the starting MV. When the starting MV are bi-prediction MVs with the two MVs pointing to different sides of the current picture (e.g., the POC of one reference is larger than the POC of the current picture, and the POC of the other reference is smaller than the POC of the current picture), the sign in Table1-2 specifies the sign of MV offset added to the list0 MV component of starting MV and the sign for the list1 MV has opposite value.

TABLE 1-2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

In ECM, the number of directions is further increased from 4 to 8 to additionally include the 4 diagonal directions.

### Bilateral Matching

Bilateral matching (BM) is a technique that refines a pair of two initial motion vectors MV0 and MV1. Generally, BM includes searching around the MV0 and MV1 to derive refined MVs MV0′ and MV1′ that minimizes the block matching cost. The block matching cost measures the similarity between the two motion compensated predictors generated by the two MVs. Some typical criterions are: sum of absolute difference (SAD), sum of absolute transformed difference (SATD), and sum of square error (SSE), among others. The cost criterion may also include a regularization term that is derived based on the MV differences between the current MV pair and the initial MV pair. Some certain constraints may also be applied to the MV differences between MVD0 (MV0′−MV0) and MVD1 (MV1′−MV1). Typically, it is assumed that MVD0 and MVD1 shall be proportional to the temporal distances (TD) between the current picture and the reference pictures pointed by the two MVs. However, in some applications, it may be assumed that MVD0 is equal to −MVD1.

### Decoder Side Motion Vector Refinement

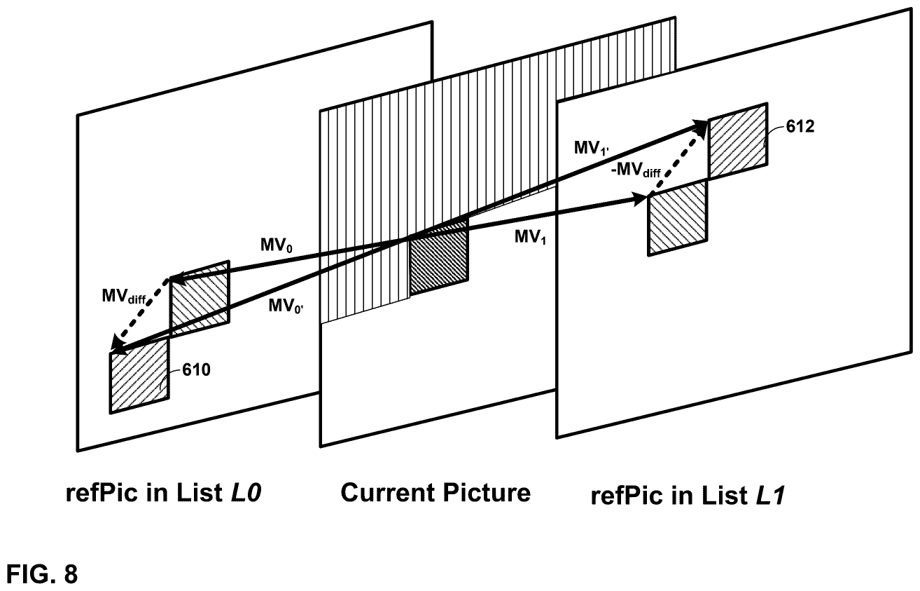

In VVC, bilateral-matching based decoder side motion vector refinement (DMVR) may be applied to increase the accuracy of the MVs of a bi-prediction merge candidate. The BM method calculates the SAD between the two candidate blocks in the reference picture list L0 and list L1. FIG. 8 is a conceptual diagram illustrating an example of bilateral matching. As illustrated in FIG. 8, the SAD between block 610 and block 612, based on each MV candidate around the initial MV, is calculated. The MV candidate with the lowest SAD becomes the refined MV and used to generate the bi-predicted signal. The SAD of the initial MVs is subtracted by ¼ of the SAD value to serve as regularization term. The temporal distances (i.e. Picture Order Count (POC) difference) from two reference pictures to the current picture shall be the same, therefore, the MVD0 is just the opposite sign of MVD1.

The refinement search range is two integer luma samples from the initial MV. The searching includes the integer sample offset search stage and fractional sample refinement stage. A 25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage.

The integer sample search is followed by fractional sample refinement. To reduce computational complexity, the fractional sample refinement is derived by using parametric error surface equation, instead of an additional search with a SAD comparison. The fractional sample refinement is conditionally invoked based on the output of the integer sample search stage. When the integer sample search stage is terminated with the center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C , \qquad ( 1 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 3 )$$

The value of xₘᵢₙ and yₘᵢₙ are automatically constrained to be between −8 and 8 since all cost values are positive and the smallest value is E(0,0). This corresponds to half-pel offset with 1/16th-pel MV accuracy in VVC. The computed fractional (xₘᵢₙ) yₘᵢₙ) are added to the integer distance refinement MV to get the sub-pixel accurate refinement delta MV.

In VVC, the resolution of the MVs is 1/16 luma samples. The samples at the fractional position are interpolated using an 8-tap interpolation filter. In DMVR, the search points are surrounding the initial fractional-pel MV with integer sample offset. Therefore, the samples of those fractional position are interpolated for the DMVR search process. To reduce the calculation complexity, a bi-linear interpolation filter is used to generate the fractional samples for the searching process in DMVR. Another important effect is that by using bi-linear filter with 2-sample search range, DVMR does not access more reference samples compared to the normal motion compensation process. After the refined MV is attained with the DMVR search process, the normal 8-tap interpolation filter is applied to generate the final prediction. In order to not access more reference samples compared to the normal motion compensation process, the samples which are not needed for the interpolation process based on the original MV, but are needed for the interpolation process based on the refined MV, will be padded from those available samples.

When the width and/or height of a CU are larger than 16 luma samples, the CU may be further split into subblocks with width and/or height equal to 16 luma samples for the DMVR process.

In VVC, DMVR can be applied for CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
Weighted prediction (WP) is not enabled for the current block
Combined inter intra prediction (CIIP) mode is not used for the current block

In ECM, the conditions are simplified:
CU level merge mode or AMVP-merge mode with bi-prediction MV
One reference picture is in the past and another reference picture is in the future with respect to the current picture
The distances (i.e. POC difference) from two reference pictures to the current picture are same
MMVD mode is not used for the current block
Both reference pictures are not scaled
WP is not enabled for the current block
CIIP mode is not used for the current block

### Template Matching (TM) Merge Mode

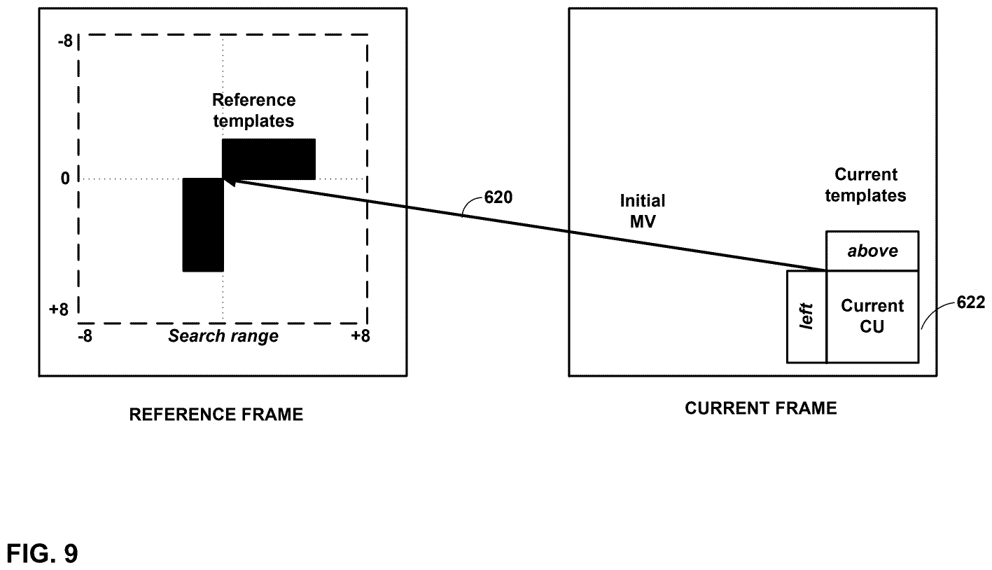

Template matching (TM) is a decoder-side MV derivation method used to refine the motion information of the current CU by finding the closest match between a template (e.g., top and/or left neighbouring blocks of the current CU) in the current picture and a block (e.g., same size to the template) in a reference picture. FIG. 9 is a conceptual diagram illustrating an example of templating matching on search area around an initial motion vector. As illustrated in FIG. 9, a better MV is searched around the initial motion vector 620 of the current CU 622 within a [−8, +8]-pel search range. The template matching method in JVET-J0021 is used with the following modifications: search step size is determined based on AMVR mode and TM can be cascaded with bilateral matching process in merge modes.

TM merge mode is a combination of regular merge mode and a template matching method. A TM merge list is first constructed similar to regular merge mode except that the MVD threshold used for candidate pruning process is different. After the TM merge list is constructed, each candidate in the list will be further refined using the template matching method. The refined motion vector will be signaled with a TM merge mode flag and a corresponding TM merge index.

### Affine Mode

An affine motion model can be described as:

$$\{ \begin{matrix}{v}_{x} = a x + b y + e \\ {v}_{y} = c x + d y + f\end{matrix} ,$$

wherein (vₓ, v_{y}) is the motion vector at the coordinate (x, y), and a, b, c, d, e, and f are the six affine parameters. We will refer to this affine motion model as a 6-parameters affine motion model. In a typical video coder, a picture is partitioned into blocks for block-based coding. The affine motion model for a block can also be described by the three motion vectors (MVs) \vec{v}₀=(vₒₓ, v_{oy}), \vec{v}₁=(v₁ₓ, v_{1y}), and \vec{v}₂=(v₂ₓ, v_{2y}) at three different locations that are not in the same line. The three locations are usually referred to as control-points, and the three motion vectors are referred to as control-point motion vectors (CPMVs). In the case when the three control-points are at the three corners of the block, the affine motion can be described as:

$$\{ \begin{matrix}{v}_{x} = \frac{( {v}_{1 x} - {v}_{0 x} )}{blkW} x + \frac{( {v}_{2 x} - {v}_{0 x} )}{blkH} y + {v}_{0 x} \\ {v}_{y} = \frac{( {v}_{1 y} - {v}_{0 y} )}{blkW} x + \frac{( {v}_{2 y} - {v}_{0 y} )}{blkH} y + {v}_{0 y}\end{matrix} ,$$

wherein blkW and blkH are the width and height of the block.

In affine mode, different motion vectors can be derived for each pixel in the block according to the associated affine motion model. Therefore, motion compensation can be performed pixel-by-pixel. However, to reduce complexity, subblock-based motion compensation is usually adopted, wherein the block is partitioned into multiple subblocks (that have smaller block size) and each subblock is associated with one motion vector for block-based motion compensation. The motion vector for each subblock is derived using the representative coordinate of the subblock. Typically, the center position is used. In one example, the block is partitioned into non-overlapping subblocks. The block width is blkW, block height is blkH, the subblock width is sbW and subblock height is sbH. Then there are blkH/sbH rows of subblocks and blkW/sbW subblocks in each row. For a six-parameter affine motion model, the motion vector for the subblock (referred to as subblock MV) at iₜₕ row (0<=i<blkW/sbW) and jₜₕ (0<=j<blkH/sbH) column is derived as:

$$\{ \begin{matrix}{v}_{x} = \frac{( {v}_{1 x} - {v}_{0 x} )}{blkW} ( j * sbW + \frac{sbW}{2} ) + \frac{( {v}_{2 x} - {v}_{0 x} )}{blkH} ( i * sbH + \frac{sbH}{2} ) + {v}_{0 x} \\ {v}_{y} = \frac{( {v}_{1 y} - {v}_{0 y} )}{blkW} ( j * sbW + \frac{sbW}{2} ) + \frac{( {v}_{2 y} - {v}_{0 y} )}{blkH} ( i * sbH + \frac{sbH}{2} ) + {v}_{0 y}\end{matrix}$$

The subblock MVs are rounded to the predefined precision and stored in a motion buffer for motion compensation and motion vector prediction.

A simplified 4-parameters affine model (for zoom and rotational motion) is described as:

$$\{ \begin{matrix}{v}_{x} = a x - b y + e \\ {v}_{y} = b x + a y + f\end{matrix}$$

Similarly, the 4-parameters affine model for a block can be described by two CPMVs \vec{v}₀=(vₒₓ, v_{oy}) and \vec{v}₁=(v₁ₓ, v_{1y}) at two corners (typically top-left and top-right) of the block. The motion field is then described as:

$$\{ \begin{matrix}{v}_{x} = \frac{( {v}_{1 x} - {v}_{0 x} )}{blkW} x - \frac{( {v}_{1 y} - {v}_{0 y} )}{blkW} y + {v}_{0 x} \\ {v}_{y} = \frac{( {v}_{1 y} - {v}_{0 y} )}{blkW} x + \frac{( {v}_{1 x} - {v}_{0 x} )}{blkW} y + {v}_{0 y}\end{matrix}$$

The subblock MV at iₜₕ row and jₜₕ column is derived as:

$$\{ \begin{matrix}{v}_{x} = \frac{( {v}_{1 x} - {v}_{0 x} )}{blkW} ( j * sbW + \frac{sbW}{2} ) - \frac{( {v}_{1 y} - {v}_{0 y} )}{blkW} ( i * sbH + \frac{sbH}{2} ) + {v}_{0 x} \\ {v}_{y} = \frac{( {v}_{1 y} - {v}_{0 y} )}{blkW} ( j * sbW + \frac{sbW}{2} ) + \frac{( {v}_{1 x} - {v}_{0 x} )}{blkW} ( i * sbH + \frac{sbH}{2} ) + {v}_{0 y}\end{matrix}$$

### Subblock-Based Temporal Motion Vector Prediction (SbTMVP)

Similar to the temporal motion vector prediction (TMVP) in HEVC, subblock-based temporal motion vector prediction (SbTMVP) uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

A combined sub-block based merge list which contains both SbTMVP candidate and affine merge candidates is used for the signalling of sub-block based merge mode.

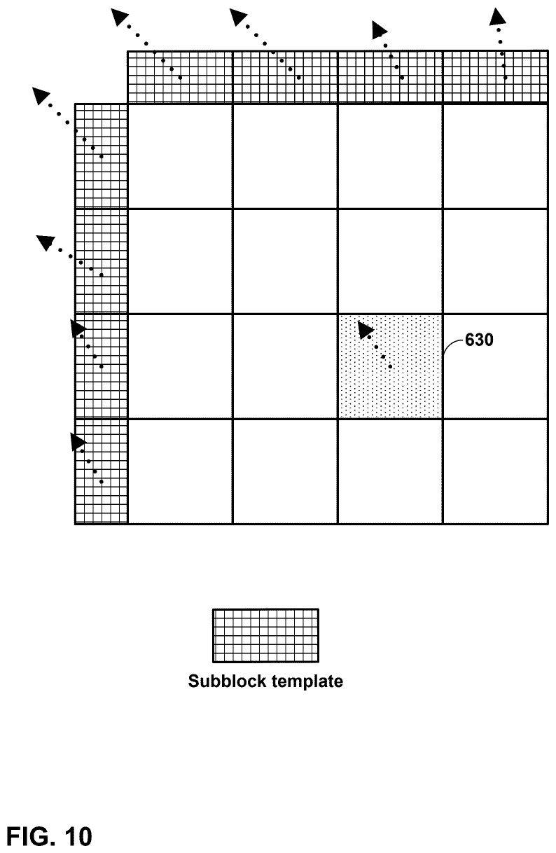

In ECM, to further improve the coding efficiency of SbTMVP, two aspects are modified. First, two collocated pictures are utilized which are the two reference frames with the least POC distance relative to the to-be-coded frame. Second, the motion shift to locate TMVP used for SbTMVP is adaptively determined from multiple locations according to template costs. More specifically, two motion shift candidate lists are constructed respectively for the two collocated frames. The motion shifts with the minimum template matching cost are used to derive SbTMVP or TMVP candidates. At most four SbTMVP candidates are included in the sub-block-based merge list. The SbTMVP candidate with the least template matching cost derived from the first collocated frame is placed in the first entry without reordering, while other SbTMVP candidates are sorted together with affine candidates. In addition, the prediction direction of each subblock template is determined based on the center subblock. FIG. 10 is a conceptual diagram illustrating an example of subblock template generation for subblock based temporal motion vector prediction. As illustrated in FIG. 10, if the center subblock 630 is uni-predicted, then all the subblock templates are uni-predicted, and vice versa. If the motion vector of corresponding adjacent subblock at the determined reference list is not available for a subblock template, a zero MV is used for that subblock template.

### Affine Merge Prediction

In affine merge mode, the CPMVs of the current CU are generated based on the motion information of the spatial neighboring CUs. There can be up to five CPMV candidates and an index is signalled to indicate the candidate to be used for the current CU. The following three types of CPMV candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In ECM, three new types of merge candidates are introduced and the affine merge candidate list is constructed as follows:
SbTMVP candidates, if available
Inherited from adjacent neighbors
Regression-based affine merge candidates
Constructed affine candidates from adjacent neighbors
Constructed affine candidates from non-adjacent neighbors
History-based affine merge candidates
Zero MVs

### Decoder Side Motion Vector Refinement for Affine Merge Mode

In J. Chen, R.-L. Liao, X. Li, Y. Ye, “Non-EE2: DMVR for affine merge coded blocks,” JVET-AA0144, July 2022 (hereinafter, “JVET-AA0144”), decoder side motion vector refinement (DMVR) is proposed for bi-directional predicted affine merge candidate. A translation MV offset is added to all the CPMVs of the candidate in the affine merge list if the candidate meets the DMVR condition. The MV offset is derived by minimizing the cost of bilateral matching, which is similar to the conventional DMVR. The difference is that affine motion compensation is performed to generate predictors in both directions. The MV offset searching process is the same as the DMVR (prediction unit level) in ECM. A 3×3 square search pattern is used to loop through the search range [−8, +8] in horizontal direction and [−8, +8] in vertical direction to find the best integer MV offset. Then a half-pel search is conducted around the best integer position and an error surface estimation is performed at last to find a MV offset with 1/16 precision.

To calculate the bilateral matching cost (for the given bi-directional affine motion), the following steps may be applied:
1) The offset is first added to each of the CPMVs in both directions to update the CPMVs.
2) Affine motion compensation is applied according to the updated CPMVs to generate the predictors in both directions.
3) Calculate the distortion between the generated predictors using the predefined cost criterion.

Typically, the affine motion compensation is subblock based, wherein the current block is partitioned into non-overlapping subblocks. Regular motion compensation is performed for each of the subblocks (all samples in the subblock share the same motion). In VVC, prediction refinement with optical flow (PROF) may be applied after the subblock based motion compensation to further improve the predictor.

In co-pending U.S. patent application Ser. No. 18/351,342, a less complex and more practical DMVR design for affine motion model is disclosed. The DMVR design can be summarized in the following steps:
1) Divide the current block into subblocks.
2) Generate initial motion vectors (of both prediction directions) for each subblock (subblock motion fields) according to the initial affine motion model.
3) Loop over each subblock, calculate subblock bilateral matching cost for all possible offsets.
4) For each possible offset, accumulate the subblock bilateral matching cost to generate the bilateral matching cost corresponding to the entire block.
5) Determine the best offset by selecting the one with minimum bilateral matching cost corresponding to the entire block.

In co-pending U.S. patent application Ser. No. 18/467,513, a subblock skipping or subsampling is disclosed to further reduce the complexity, wherein a subset of subblocks may be used during the affine DMVR process.

### Multi-Pass Decoder-Side Motion Vector Refinement in ECM

A multi-pass decoder-side motion vector refinement may be applied in ECM. In the first pass, bilateral matching (BM) is applied to the coding block. In the second pass, BM is applied to each 16×16 subblock within the coding block. In the third pass, a MV in each 8×8 subblock is refined by applying bi-directional optical flow (BDOF). The refined MVs are stored for both spatial and temporal motion vector prediction.

### First Pass-Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initial MVs based on the minimum bilateral matching cost between the two reference blocks in L0 and L1.

BM performs a local search to derive integer sample precision intDeltaMV. The local search applies a 3×3 square search pattern to loop through the search range [−sHor, sHor] in horizontal direction and [−sVer, sVer] in vertical direction, wherein the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, a mean removed sum of absolute differences (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continues to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV$$

$$MV1\_pass1 = MV 1 - deltaMV$$

### Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs a full search to derive integer sample precision intDeltaMV. The full search has a search range [−sHor, sHor] in horizontal direction and [−sVer, sVer] in vertical direction, wherein the values of sHor and sVer are determined by the block dimension. The maximum value of sHor and sVer is 8.

The bilateral matching cost is calculated by applying a cost factor to the SATD cost between two reference subblocks as: bilCost=satdCost*costFactor. The search area (2*sHor+1)*(2*sVer+1) is divided into a five diamond shape search regions. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated. Otherwise, the int-pel full search continues to the next search region until all search points are examined.

The existing VVC DMVR fractional sample refinement is further applied to derive the final deltaMV (sbIdx2). The refined MVs at the second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

### Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

### Bi-Directional Optical Flow

Bi-directional optical flow (BDOF) is used to refine the bi-prediction signal of luma samples in a CU at the 4×4 sub-block level. As its name indicates, the BDOF mode is based on the optical flow concept, which assumes that the motion of an object is smooth. For each 4×4 sub-block, a motion refinement (vₓ, v_{y}) is calculated by minimizing the difference between the L0 and L1 prediction samples. The motion refinement is then used to adjust the bi-predicted sample values in the 4×4 sub-block. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, e.g., as:

$$\frac{\partial {I}^{( k )}}{\partial x} ( i , j ) = ( {I}^{( k )} ( i + 1 , j ) >> shift1 ) - ( {I}^{( k )} ( i - 1 , j ) >> shift1 ) \qquad ( 1 - 6 - 1 )$$

$$\frac{\partial {I}^{( k )}}{\partial y} ( i , j ) = ( {I}^{( k )} ( i , j + 1 ) >> shift1 ) - ( {I}^{( k )} ( i , j - 1 ) >> shift1 )$$

where I^{(k)}(i, j) are the sample value at coordinate (i, j) of the prediction signal in list k, k=0,1, and shift1 is calculated based on the luma bit depth, bitDepth, as shift1 is set to be equal to 6.

Then, the auto-correlation and cross-correlation of the gradients, S₁, S₂, S₃, S₅ and S₆, are calculated as:

$${S}_{1} = {\sum }_{( i , j ) ∈ Ω} \vert {ψ}_{x} ( i , j ) \vert , {S}_{3} = {\sum }_{( i , j ) ∈ Ω} θ ( i , j ) \cdot ( - sign ( {ψ}_{x} ( i , j ) ) ) \qquad ( 1 - 6 - 2 )$$

$${S}_{2} = {\sum }_{( i , j ) ∈ Ω} {ψ}_{x} ( i , j ) \cdot sign ( {ψ}_{y} ( i , j ) )$$

$${S}_{5} = {\sum }_{( i , j ) ∈ Ω} \vert {ψ}_{y} ( i , j ) \vert {S}_{6} = {\sum }_{( i , j ) ∈ Ω} θ ( i , j ) \cdot ( - sign ( {ψ}_{y} ( i , j ) ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> shift3 \qquad ( 1 - 6 - 3 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> shift3$$

$$θ ( i , j ) = ( {I}^{( 0 )} ( i , j ) >> shift2 ) - ( {I}^{( 1 )} ( i , j ) >> shift2 )$$

where Ω is a 6×6 window around the 4×4 sub-block, the value of shift2 is set to be equal to 4, and the value of shift3 is set to be equal to 1.

The motion refinement (vₓ, v_{y}) is then derived using the cross-correlation and auto-correlation terms using the following:

$${v}_{x} = {S}_{1} > 0 ? clip 3 ( - t {h}_{BIO}^{′} , {th}_{BIO}^{′} , - ( ( {S}_{3} << 2 ) >> ⌊ {log}_{2} {S}_{1} ⌋ ) ) : 0 \qquad ( 1 - 6 - 4 )$$

$${v}_{y} = {S}_{5} > 0 ? clip 3 ( - t {h}_{BIO}^{′} , t {h}_{BIO}^{′} , - ( ( ( {S}_{6} << 2 ) - ( ( {v}_{x} \cdot {S}_{2} ) >> 1 ) ) >> ⌊ {log}_{2} {S}_{5} ⌋ ) ) : 0$$

where, th′_{BIO}=1<<4. └·┘ is the floor function.

Based on the motion refinement and the gradients, the following adjustment is calculated for each sample in the 4×4 sub-block:

$$b ( x , y ) = {v}_{x} \cdot ( \frac{\partial {I}^{( 1 )} ( x , y )}{\partial x} - \frac{\partial {I}^{( 0 )} ( x , y )}{\partial x} ) + {v}_{y} \cdot ( \frac{\partial {I}^{( 1 )} ( x , y )}{\partial y} - \frac{\partial {I}^{( 0 )} ( x , y )}{\partial y} ) \qquad ( 1 - 6 - 5 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) >> shift5 \qquad ( 1 - 6 - 6 )$$

wherein shift5 is set equal to Max (3, 15−BitDepth) and the variable o_{offset} is set equal to (1<< (shift5−1)).

These values are selected such that the multipliers in the BDOF process do not exceed 15-bits, and the maximum bit-width of the intermediate parameters in the BDOF process is kept within 32-bits.

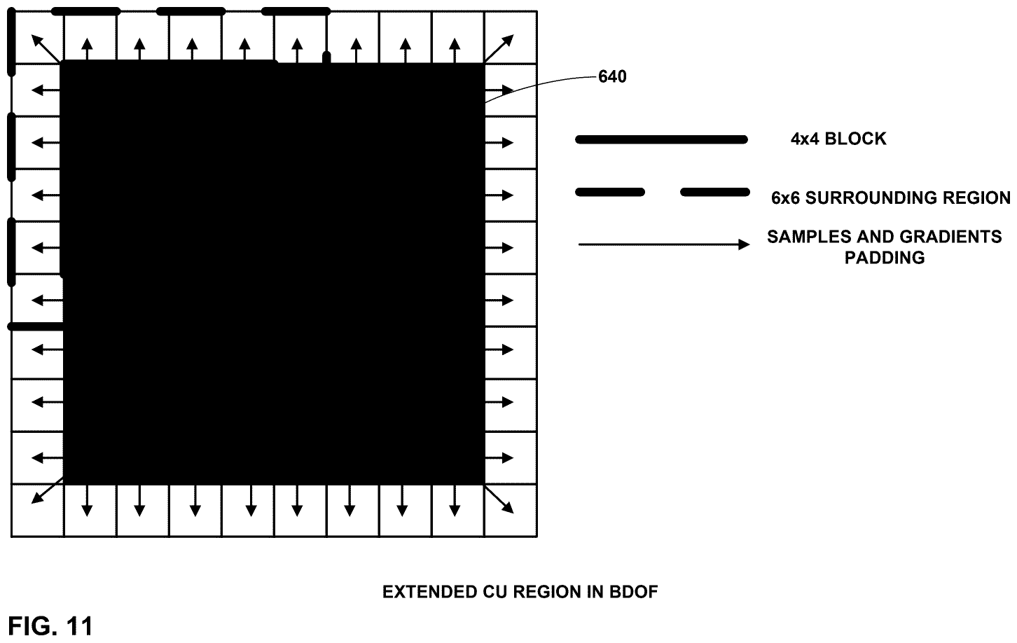

In order to derive the gradient values, some prediction samples I^{(k)}(i, j) in list k (k=0,1) outside of the current CU boundaries may be generated. FIG. 11 is a conceptual diagram illustrating an example of an extended coding unit region used in bi-directional optical flow. As depicted in FIG. 11, the BDOF uses one extended row/column around the boundaries of CU 640. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The CU is not coded using affine mode or the ATMVP merge mode
CU has more than 64 luma samples
Both CU height and CU width are larger than or equal to 8 luma samples
BCW weight index indicates equal weight
WP is not enabled for the current CU
CIIP mode is not used for the current CU

### Bi-Directional Optical Flow—Multi-Iteration MV Refinement

In M. Salehifar, et. al., “EE-3.5: Iterative BDOF pass in multi-pass DMVR,” Joint Video Experts Team (JVET) of ITU-T SG 16 WP 3 and ISO/IEC 1/SC 29, 31^{st} Meeting, Geneva, CH, 11-19 Jul. 2023 (hereinafter, “JVET-AE0065”), a method of iterative BDOF pass in multi-pass DMVR was proposed and included in ECM. The method proposes to extend the multi-pass DMVR by adding 4-th BDOF MV refinement pass. The maximum subblock size of the 3rd BDOF MV refinement pass is always 8×8, and maximum subblock size of the 4th BDOF MV refinement pass is adaptively set to 4×4 when the coding block size is smaller than 1024 and 8×8 otherwise. When the subblock in the 3rd BDOF MV refinement pass derives a delta motion with Vx is equal to 0 and Vy is equal to 0, the 4th BDOF MV refinement pass is skipped.

### Examples

Currently in ECM, for merge mode, the LIC flag is inherited from the neighboring blocks. If the LIC flag is true, video encoder 200 and video decoder 300 are configured to derive the LIC parameters for the current block from the neighboring template in the reconstructed samples and reference template in the reference frame.

In this disclosure, video encoder 200 and video decoder 300 are configured to adaptively use LIC parameters that are already derived for an already coded block (e.g., a neighboring block) relative to the current block, instead of deriving a new set of parameters from the template. Whether or not to use the stored LIC parameters depends on the merge candidate type for the merge candidate determined for the current block. The following described examples can be used individually or combined.

In one example, if a merge candidate is a non-adjacent candidate and/or history-based motion vector prediction candidate, video encoder 200 and video decoder 300 are configured to use, for the current block, the stored LIC parameters (e.g., already derived LIC parameters) from the referenced neighboring block of the merge candidate. Here, non-adjacent candidate means that the reference block of the merge candidate does not share the same boundary with current block. In some examples, a minimum distance can be defined for the non-adjacent candidate that use the stored LIC parameters. That is, the non-adjacent candidate may be a threshold number of samples away from a boundary for the first block of video data.

Accordingly, in on example of the disclosure, video encoder 200 and video decoder 300 may receive a first block of video data to be coded using merge mode and LIC. Video encoder 200 and video decoder 300 may determine a first merge candidate for the first block of video data. If the first merge candidate is a non-adjacent candidate or a history-based motion vector predictor candidate, video encoder 200 and video decoder 300 may inherit (e.g., reuse) first LIC parameters associated with the first merge candidate. Video encoder 200 and video decoder 300 may then code (e.g., encode or decode) the first block of video data using the first merge candidate and the first LIC parameters.

The use of a non-adjacent merge candidate or history-based motion vector predictor may be suggestive that adjacent blocks (e.g., adjacent merge candidates) are significantly different than the current block, at least in terms of having correlated motion information. As such, deriving new LIC parameters using adjacent samples in this situation may lead to less optimal LIC parameters. Accordingly, inheriting LIC parameters associated with the non-adjacent merge candidate or history-based motion vector predictor may lead to better coding efficiency and/or reduced distortion.

In a further example, video encoder 200 and video decoder 300 may receive a second block of video data to be coded using merge mode and LIC. Video encoder 200 and video decoder 300 may determine a second merge candidate for the second block of video data. If the second merge candidate is an adjacent candidate (e.g., shares a boundary with the second block), video encoder 200 and video decoder 300 may derive second LIC parameters for the second block of video data using a neighboring template of reconstructed samples and a reference template in a reference frame. Video encoder 200 and video decoder 300 may then code (e.g., encode or decode) the second block of video data using the second merge candidate and the second LIC parameters.

Note that the LIC parameters are stored in a buffer in the techniques of this disclosure, which might increase the memory usage for the codec. Therefore, in another example, the LIC parameters are only stored alongside a history-based motion vector prediction (HMVP) candidate. The HMVP candidates are stored in a list of limited size, therefore the required memory is small.

In another example, video encoder 200 and video decoder 300 operate according to a constraint where the non-adjacent candidate that uses the stored LIC parameters is within the current CTU and/or is positioned at the CTU boundary, such that the LIC parameters only need to be stored for current CTU. The LIC parameters may be stored in a line buffer if blocks at a CTU boundary are used as well. In another example, video encoder 200 and video decoder 300 may be further figured to quantize the LIC parameters before they are stored in a buffer or memory.

In another example, for each N×N area, video encoder 200 and video decoder 300 are configured to store at most one set of LIC parameters. When obtaining a neighboring spatial candidate for the merge mode, video encoder 200 and video decoder 300 may be configured to fetch the LIC parameters only from a position that is within the N×N grid. For example, N can be 8×8, 16×16, or other size.

In another example, the candidate that uses LIC parameters is added as an additional candidate together with the candidate that indicates using a template to derive a new LIC model. That is, given the same neighboring block, video encoder 200 and video decoder 300 may be configured to derive two candidates. One of the candidates inherits the LIC flag. That is, video encoder 200 and video decoder 300 may derive LIC parameters using a template. The other candidate inherits the parameters, as described in above. The two candidates have the same motion information but have different ways to derive the LIC parameters.

The proposed techniques described above for inheriting LIC parameters can be controlled by a flag signaled in high level syntax, e.g., an SPS flag, picture parameter set flag, a picture header flag, a slice header flag, or at other syntax structures. The flag can be further conditioned by whether LIC is enabled. That is, the flag that allows for the inheriting of LIC parameters based on merge candidate type need not be coded if LIC is disabled.

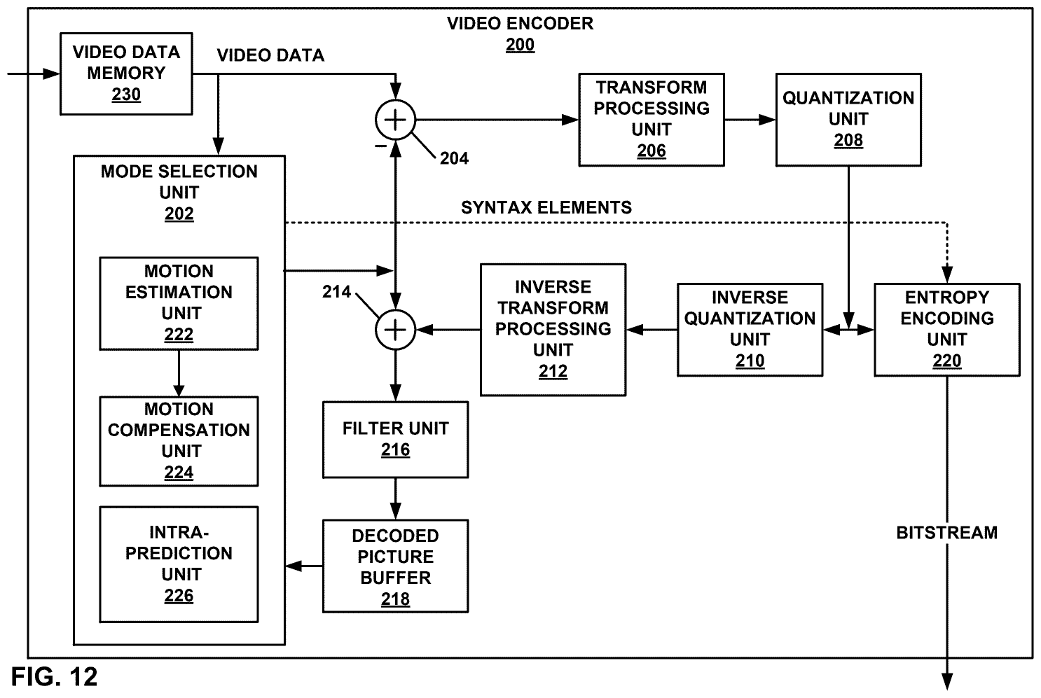

FIG. 12 is a block diagram illustrating an example video encoder 200 that may perform the techniques of this disclosure. FIG. 12 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 12, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 12 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure, superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to receive a first block of video data to be coded using merge mode and LIC, and determine a first merge candidate for the first block of video data. If the first merge candidate is a non-adjacent candidate or a history-based motion vector predictor candidate, video encoder 200 may inherit (e.g., reuse) first LIC parameters associated with the first merge candidate. Video encoder 200 may then encode the first block of video data using the first merge candidate and the first LIC parameters.

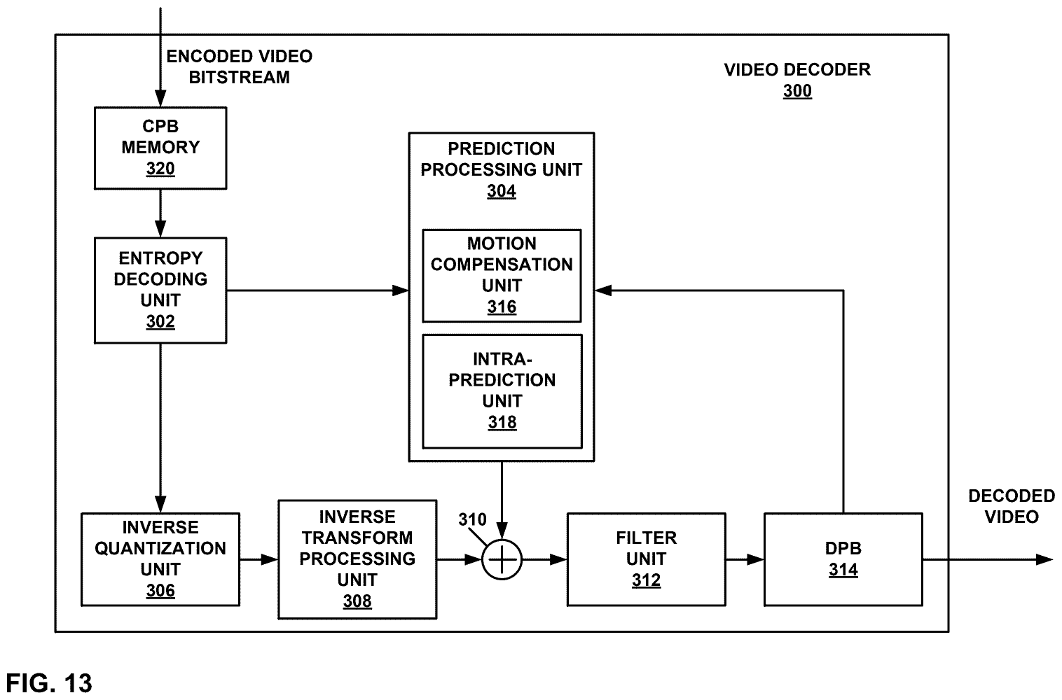

FIG. 13 is a block diagram illustrating an example video decoder 300 that may perform the techniques of this disclosure. FIG. 13 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 13, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 13 are illustrated to assist with understanding the operations performed by video decoder 300. The units may be implemented as fixed-function circuits, programmable circuits, or a combination thereof. Similar to FIG. 12, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 12).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 12). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to receive a first block of video data to be coded using merge mode and LIC, and determine a first merge candidate for the first block of video data. If the first merge candidate is a non-adjacent candidate or a history-based motion vector predictor candidate, video decoder 300 may inherit (e.g., reuse) first LIC parameters associated with the first merge candidate. Video decoder 300 may then decode the first block of video data using the first merge candidate and the first LIC parameters.

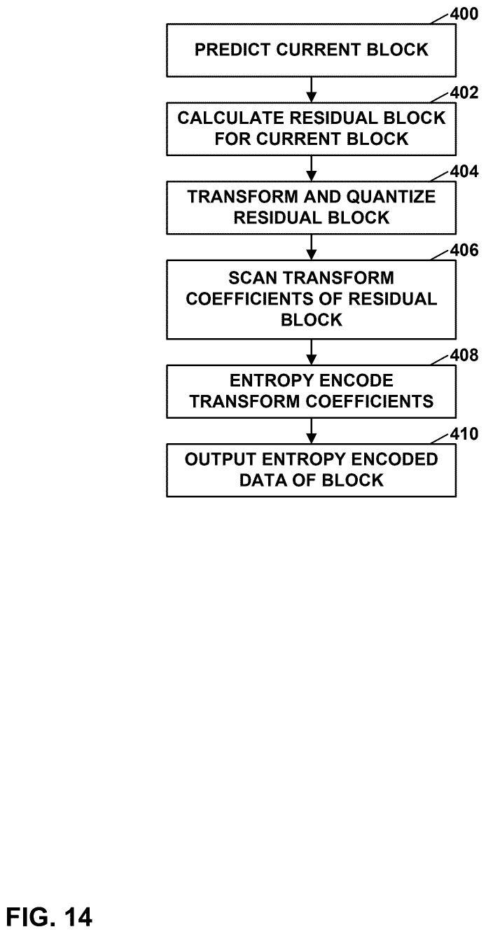

FIG. 14 is a flowchart illustrating an example method for encoding a current block in accordance with the techniques of this disclosure. The current block may be or include a current CU. Although described with respect to video encoder 200 (FIGS. 1 and 12), it should be understood that other devices may be configured to perform a method similar to that of FIG. 14.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

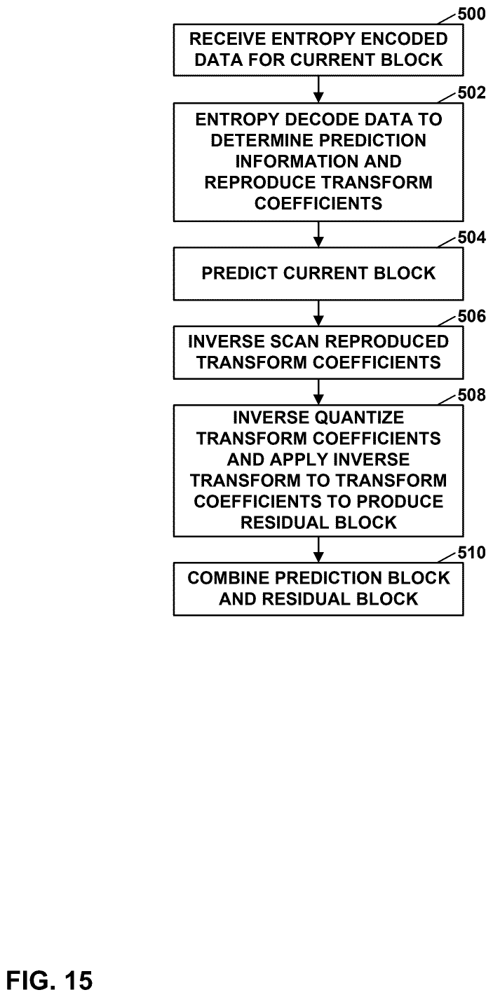

FIG. 15 is a flowchart illustrating an example method for decoding a current block of video data in accordance with the techniques of this disclosure. The current block may be or include a current CU. Although described with respect to video decoder 300 (FIGS. 1 and 13), it should be understood that other devices may be configured to perform a method similar to that of FIG. 15.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

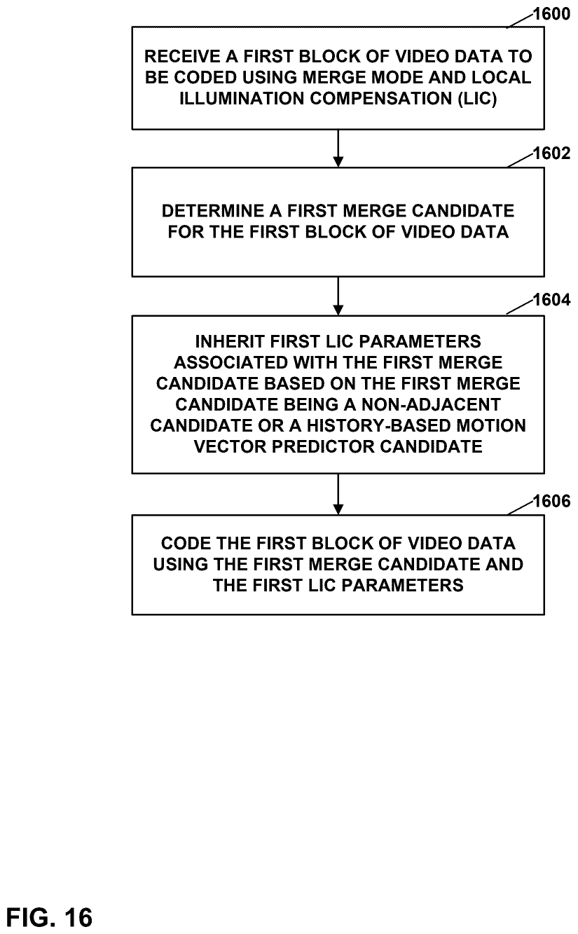

FIG. 16 is a flowchart illustrating another example method for coding a current block in accordance with the techniques of this disclosure. The techniques of FIG. 16 may be performed by video encoder 200 and video decoder 300.

In one example, video encoder 200 and video decoder 300 are configured to receive a first block of video data to be coded using merge mode and local illumination compensation (LIC) (1600). Video encoder 200 and video decoder 300 may determine a first merge candidate for the first block of video data (1602). Video encoder 200 and video decoder 300 may then inherit first LIC parameters associated with the first merge candidate based on the first merge candidate being a non-adjacent candidate or a history-based motion vector predictor candidate (1604), and code the first block of video data using the first merge candidate and the first LIC parameters (1606).

In one example, the first merge candidate is a non-adjacent candidate that is a threshold number of samples away from a boundary for the first block of video data.

In another example, the first merge candidate is a non-adjacent candidate, and video encoder 200 and video decoder 300 are further configured to store the first LIC parameters for the non-adjacent candidate based on the non-adjacent candidate being within a current coding tree unit of the first block of video data or at a boundary of the current coding tree unit of the first block of video data.

In another example, the first merge candidate is a history-based motion vector predictor candidate, and video encoder 200 and video decoder 300 are configured to store the first LIC parameters with the history-based motion vector prediction candidate.

In another example, the first LIC parameters are a single set of LIC parameters stored for an N×N area of the video data.

In another example, video encoder 200 and video decoder 300 are further configured to quantize the first LIC parameters before storing in a buffer and before inheriting the first LIC parameters.

In another example, video encoder 200 and video decoder 300 are further configured to receive a second block of video data to be coded using merge mode and LIC, determine a second merge candidate for the second block of video data, derive second LIC parameters for the second block of video data using a neighboring template of reconstructed samples and a reference template in a reference frame based on the second merge candidate being an adjacent candidate, and code the second block of video data using the second merge candidate and the second LIC parameters.

The following numbered clauses illustrate one or more aspects of the devices and techniques described in this disclosure.
Aspect 1A—A method of coding video data, the method comprising: deriving neighbor local illumination compensation (LIC) parameters for a neighboring block of video data; determining to the use the neighbor LIC parameters for a current block based on a candidate type; and coding the current block using the neighbor LIC parameters.
Aspect 2A—The method of Aspect 1A, wherein the candidate type is a non-adjacent candidate or a history-based motion vector prediction candidate.
Aspect 3A—The method of Aspect 2A, further comprising: storing the LIC parameters with the history-based motion vector prediction candidate.
Aspect 4A—The method of Aspect 2A, further comprising: storing the LIC parameters for the non-adjacent candidate based on the non-adjacent candidate with a current coding tree unit or at a boundary of the coding tree unit.
Aspect 5A—The method of Aspect 1A, further comprising: quantizing the neighbor LIC parameters.
Aspect 6A—The method of any of Aspects 1A-5A, wherein coding comprises decoding.
Aspect 7A—The method of any of Aspects 1A-5A, wherein coding comprises encoding.
Aspect 8A—A device for coding video data, the device comprising one or more means for performing the method of any of Aspects 1A-7A.
Aspect 9A—The device of Aspect 8A, wherein the one or more means comprise one or more processors implemented in circuitry.
Aspect 10A—The device of any of Aspects 8A and 9A, further comprising a memory to store the video data.
Aspect 11A—The device of any of Aspects 8A-10A, further comprising a display configured to display decoded video data.
Aspect 12A—The device of any of Aspects 8A-11A, wherein the device comprises one or more of a camera, a computer, a mobile device, a broadcast receiver device, or a set-top box.
Aspect 13A—The device of any of Aspects 8A-12A, wherein the device comprises a video decoder.
Aspect 14A—The device of any of Aspects 8A-13A, wherein the device comprises a video encoder.
Aspect 15A—A computer-readable storage medium having stored thereon instructions that, when executed, cause one or more processors to perform the method of any of Aspects 1A-7A.
Aspect 1B—A method of coding video data, the method comprising: receiving a first block of video data to be coded using merge mode and local illumination compensation (LIC); determining a first merge candidate for the first block of video data; inheriting first LIC parameters associated with the first merge candidate based on the first merge candidate being a non-adjacent candidate or a history-based motion vector predictor candidate; and coding the first block of video data using the first merge candidate and the first LIC parameters.
Aspect 2B—The method of Aspect 1B, wherein the first merge candidate is the non-adjacent candidate being a threshold number of samples away from a boundary for the first block of video data.
Aspect 3B—The method of any of Aspects 1B-2B, wherein the first merge candidate is the non-adjacent candidate, the method further comprising: storing the first LIC parameters for the non-adjacent candidate based on the non-adjacent candidate being within a current coding tree unit of the first block of video data or at a boundary of the current coding tree unit of the first block of video data.
Aspect 4B—The method of Aspect 1B, wherein the first merge candidate is the history-based motion vector predictor candidate, the method further comprising: storing the first LIC parameters with the history-based motion vector prediction candidate.
Aspect 5B—The method of any of Aspects 1B-4B, wherein the first LIC parameters are a single set of LIC parameters stored for an N×N area of the video data.
Aspect 6B—The method of any of Aspects 1B-5B, further comprising: quantizing the first LIC parameters before storing in a buffer and before inheriting the first LIC parameters.
Aspect 7B—The method of any of Aspects 1B-6B, further comprising: receiving a second block of video data to be coded using merge mode and LIC; determining a second merge candidate for the second block of video data; deriving second LIC parameters for the second block of video data using a neighboring template of reconstructed samples and a reference template in a reference frame based on the second merge candidate being an adjacent candidate; and coding the second block of video data using the second merge candidate and the second LIC parameters.
Aspect 8B—The method of any of Aspects 1B-7B, wherein coding comprises decoding.
Aspect 9B—The method of any of Aspects 1B-7B, wherein coding comprises encoding.
Aspect 10B—An apparatus configured to code video data, the apparatus comprising: a memory; and processing circuitry in communication with the memory, the processing circuitry configured to: receive a first block of video data to be coded using merge mode and local illumination compensation (LIC); determine a first merge candidate for the first block of video data; inherit first LIC parameters associated with the first merge candidate based on the first merge candidate being a non-adjacent candidate or a history-based motion vector predictor candidate; and code the first block of video data using the first merge candidate and the first LIC parameters.
Aspect 11B—The apparatus of Aspect 10B, wherein the first merge candidate is the non-adjacent candidate being a threshold number of samples away from a boundary for the first block of video data.
Aspect 12B—The apparatus of any of Aspects 10B-11B, wherein the first merge candidate is the non-adjacent candidate, and wherein the processing circuitry is further configured to: store the first LIC parameters for the non-adjacent candidate based on the non-adjacent candidate being within a current coding tree unit of the first block of video data or at a boundary of the current coding tree unit of the first block of video data.
Aspect 13B—The apparatus of Aspect 10B, wherein the first merge candidate is the history-based motion vector predictor candidate, and wherein the processing circuitry is further configured to: store the first LIC parameters with the history-based motion vector prediction candidate.
Aspect 14B—The apparatus of any of Aspects 10B-13B, wherein the first LIC parameters are a single set of LIC parameters stored for an N×N area of the video data.
Aspect 15B—The apparatus of any of Aspects 10B-14B, wherein the processing circuitry is further configured to: quantize the first LIC parameters before storing in a buffer and before inheriting the first LIC parameters.
Aspect 16B—The apparatus of any of Aspects 10B-15B, wherein the processing circuitry is further configured to: receive a second block of video data to be coded using merge mode and LIC; determine a second merge candidate for the second block of video data; derive second LIC parameters for the second block of video data using a neighboring template of reconstructed samples and a reference template in a reference frame based on the second merge candidate being an adjacent candidate; and code the second block of video data using the second merge candidate and the second LIC parameters.
Aspect 17B—The apparatus of any of Aspects 10B-16B, wherein the processing circuitry is configured to decode video data.
Aspect 18B—The apparatus of any of Aspects 10B-16B, wherein the processing circuitry is configured to encode video data.
Aspect 19B—A non-transitory computer-readable storage medium storing instructions that, when executed, cause one or more processors of a device configured to code video data to: receive a first block of video data to be coded using merge mode and local illumination compensation (LIC); determine a first merge candidate for the first block of video data; inherit first LIC parameters associated with the first merge candidate based on the first merge candidate being a non-adjacent candidate or a history-based motion vector predictor candidate; and code the first block of video data using the first merge candidate and the first LIC parameters.
Aspect 20B—The non-transitory computer-readable storage medium of Aspect 19B, wherein the instructions further cause the one or more processors to: receive a second block of video data to be coded using merge mode and LIC; determine a second merge candidate for the second block of video data; derive second LIC parameters for the second block of video data using a neighboring template of reconstructed samples and a reference template in a reference frame based on the second merge candidate being an adjacent candidate; and code the second block of video data using the second merge candidate and the second LIC parameters.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
receiving a first block of video data to be coded using merge mode and local illumination compensation (LIC);
determining a first merge candidate for the first block of video data;
inheriting first LIC parameters associated with the first merge candidate based on the first merge candidate being a non-adjacent candidate or a history-based motion vector predictor candidate; and
coding the first block of video data using the first merge candidate and the first LIC parameters.

2. The method of claim 1, wherein the first merge candidate is the non-adjacent candidate being a threshold number of samples away from a boundary for the first block of video data.

3. The method of claim 1, wherein the first merge candidate is the non-adjacent candidate, the method further comprising:
storing the first LIC parameters for the non-adjacent candidate based on the non-adjacent candidate being within a current coding tree unit of the first block of video data or at a boundary of the current coding tree unit of the first block of video data.

4. The method of claim 1, wherein the first merge candidate is the history-based motion vector predictor candidate, the method further comprising:
storing the first LIC parameters with the history-based motion vector prediction candidate.

5. The method of claim 1, wherein the first LIC parameters are a single set of LIC parameters stored for an N×N area of the video data.

6. The method of claim 1, further comprising:
quantizing the first LIC parameters before storing in a buffer and before inheriting the first LIC parameters.

7. The method of claim 1, further comprising:
receiving a second block of video data to be coded using merge mode and LIC;
determining a second merge candidate for the second block of video data;
deriving second LIC parameters for the second block of video data using a neighboring template of reconstructed samples and a reference template in a reference frame based on the second merge candidate being an adjacent candidate; and
coding the second block of video data using the second merge candidate and the second LIC parameters.

8. The method of claim 1, wherein coding comprises decoding.

9. The method of claim 1, wherein coding comprises encoding.

10. An apparatus configured to code video data, the apparatus comprising:
a memory; and
processing circuitry in communication with the memory, the processing circuitry configured to:
receive a first block of video data to be coded using merge mode and local illumination compensation (LIC);
determine a first merge candidate for the first block of video data;
inherit first LIC parameters associated with the first merge candidate based on the first merge candidate being a non-adjacent candidate or a history-based motion vector predictor candidate; and
code the first block of video data using the first merge candidate and the first LIC parameters.

11. The apparatus of claim 10, wherein the first merge candidate is the non-adjacent candidate being a threshold number of samples away from a boundary for the first block of video data.

12. The apparatus of claim 10, wherein the first merge candidate is the non-adjacent candidate, and wherein the processing circuitry is further configured to:
store the first LIC parameters for the non-adjacent candidate based on the non-adjacent candidate being within a current coding tree unit of the first block of video data or at a boundary of the current coding tree unit of the first block of video data.

13. The apparatus of claim 10, wherein the first merge candidate is the history-based motion vector predictor candidate, and wherein the processing circuitry is further configured to:
store the first LIC parameters with the history-based motion vector prediction candidate.

14. The apparatus of claim 10, wherein the first LIC parameters are a single set of LIC parameters stored for an N×N area of the video data.

15. The apparatus of claim 10, wherein the processing circuitry is further configured to:
quantize the first LIC parameters before storing in a buffer and before inheriting the first LIC parameters.

16. The apparatus of claim 10, wherein the processing circuitry is further configured to:
receive a second block of video data to be coded using merge mode and LIC;
determine a second merge candidate for the second block of video data;
derive second LIC parameters for the second block of video data using a neighboring template of reconstructed samples and a reference template in a reference frame based on the second merge candidate being an adjacent candidate; and
code the second block of video data using the second merge candidate and the second LIC parameters.

17. The apparatus of claim 10, wherein the processing circuitry is configured to decode video data.

18. The apparatus of claim 10, wherein the processing circuitry is configured to encode video data.

19. A non-transitory computer-readable storage medium storing instructions that, when executed, cause one or more processors of a device configured to code video data to:
receive a first block of video data to be coded using merge mode and local illumination compensation (LIC);
determine a first merge candidate for the first block of video data;
inherit first LIC parameters associated with the first merge candidate based on the first merge candidate being a non-adjacent candidate or a history-based motion vector predictor candidate; and
code the first block of video data using the first merge candidate and the first LIC parameters.

20. The non-transitory computer-readable storage medium of claim 19, wherein the instructions further cause the one or more processors to:
receive a second block of video data to be coded using merge mode and LIC;
determine a second merge candidate for the second block of video data;
derive second LIC parameters for the second block of video data using a neighboring template of reconstructed samples and a reference template in a reference frame based on the second merge candidate being an adjacent candidate; and
code the second block of video data using the second merge candidate and the second LIC parameters.
